(19) United States
(12) Patent Application Publication
(10) Pub. No.: US 2016/0300182 A1
(43) Pub. Date: Oct. 13, 2016

(54) POG ADJACENCY DETERMINATION

(71) Applicant: Point Inside, Inc., Bellevue, WA (US)

(72) Inventors: Tanya Salyers, Seattle, WA (US); Evan Jacobs, Seattle, WA (US); Zachary M. Lawson, Seattle, WA (US); Arun Veettil, Issaquah, WA (US); Keane Watterson, Seattle, WA (US); Dustin Brownell, North Bend, WA (US); Steighton Lee Haley, Seattle, WA (US); Preet Bawa, Lynnwood, WA (US); Michael Moricz, Bellevue, WA (US)

(21) Appl. No.: 15/093,614

(22) Filed: Apr. 7, 2016

Related U.S. Application Data
(60) Provisional application No. 62/144,220, filed on Apr. 7, 2015.

(51) Int. Cl. G06Q 10/08

(52) U.S. Cl. CPC G06Q 10/087

(57) ABSTRACT

In embodiments, a schema or map of bays for a venue is created; the schema may include dimensions, aisles, and the names of the POGs found in the venue. Within the schema, adjacent POGs and connected bays are determined. “POG configurations” for a POG (isolated or contiguous segments of a given POG within a venue) are determined. Each set of POG configurations for a POG in a venue is a “layout” of the POG. Layouts are compared across venues and a graphical user interface gets and displays information so that a POG and adjacent POGs can be compared across venues for a merchant.

### CROSS-REFERENCE TO RELATED APPLICATION(S)

This application claims the benefit of priority to U.S. Provisional Patent Application No. 62/144,220; filed Apr. 7, 2015 under Attorney Docket No. POIN-2015016; titled POG ADJACENCY. The above-cited application is hereby incorporated by reference, in its entirety, for all purposes.

### TECHNICAL FIELD

The present disclosure relates to the field of computing. More particularly, the present disclosure relates to a method, apparatus, and system to determine the adjacency of items in a venue.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Big stock retailers go through a very manual process when planning where departments will go in stores, how much space each department will occupy, the number and configuration of shelves in each department, and the like.

Store planners spend multiple hours in conference rooms with markers and computer aided design (“CAD”) printouts, red-lining the printouts to determine which POGs are in which stores (also referred to herein as “venues”) in which configurations so that it can be fully understood what it means to change a POG. For instance a planner may ask, “If we grow the ‘chewing gum’ POG by one bay in the checkout area of one store, what other POGs will be impacted”?

In addition, Store planners often try to design consistent layouts between multiple stores so that different stores can be navigated in a consistent manner by customers who travel. Consequently, store planners would like to know which stores are the same or similar, so that they can know how many other stores will have to change to maintain consistency. Complicating this analysis, a given retailer may have tens, hundreds, or even thousands of venues, so the question of the adjacency of products in different stores can involve bewildering detail.

### BRIEF DESCRIPTION OF THE DRAWINGS

Embodiments of the POG adjacency determination techniques of the present disclosure may overcome some or all of the above noted limitations. The technique will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a first example of a plan-view of a venue, with components labeled according to the present disclosure.

FIG. 2 illustrates a second example of a plan-view of a venue, with components labeled according to the present disclosure.

FIG. 3 is a network and device diagram illustrating exemplary computer devices, networks and physical arrangement of components configured according to the present disclosure.

FIG. 4 is a block diagram of an example of a POIN Server, including processors, memory components, and modules therein.

FIG. 5 is a block diagram of an example of a POIN Server Datastore, including examples of data records therein.

FIG. 6 is a flow diagram illustrating an example/algorithmic structure of a Bay Map Module, according to various embodiments.

FIG. 7 is a flow diagram illustrating an example/algorithmic structure of a Bay Connection Module, according to various embodiments.

FIG. 8 is a flow diagram illustrating an example/algorithmic structure of an Adjacency via SVG Analysis Module, according to various embodiments.

FIG. 9 is a flow diagram illustrating an example/algorithmic structure of an Adjacency via Pathway Analysis Module, according to various embodiments.

FIG. 10 is a flow diagram illustrating an example/algorithmic structure of an Adjacency via Aisle Module, according to various embodiments.

FIG. 11 is a flow diagram illustrating an example/algorithmic structure of POG Configuration Layout Module, according to various embodiments.

FIG. 12 is a flow diagram illustrating an example/algorithmic structure of Cross-Venue Comparison Module, according to various embodiments.

FIG. 13 is a flow diagram illustrating an example/algorithmic structure of GUI Module, according to various embodiments.

### DETAILED DESCRIPTION

The following description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein”, “above”, “below” and words of similar import, when used in this application, shall refer to this application as a whole and not to particular portions of this application. When the context permits, words in the above Detailed Description using the singular may also include the plural while words using the plural may also include the singular. The word “or,” in reference to a list of two or more items, covers all of the following interpretations of the word: any of the items in the list, all of the items in the list, and any combination of one or more of the items in the list.

In overview, apparatuses, methods and storage media associated with determining planogram or POG adjacency and outputting these determinations for multiple stores or venues are described herein. A schema or map of bays for a venue may be created; the schema may include dimensions, aisles, and the names of the POGs found in the venue. Within the schema, adjacent POGs and connected bays may be determined. “POG configurations” for a POG may be determined, which are isolated or contiguous segments of a given POG within a venue. Each set of POG configurations for a POG in a venue is a “layout” of the POG. Layouts may be compared across venues and a graphical user interface gets and displays information so that a POG and adjacent POGs can be compared across venues for a merchant.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “at least one of A, B, or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), a System on a Chip (SoC), an electronic circuit, a processor (shared, dedicated, or group) and/or memory (shared, dedicated, or group) that execute one or more software or firmware programs, a combinational logic circuit, and/or other suitable components that provide the described functionality.

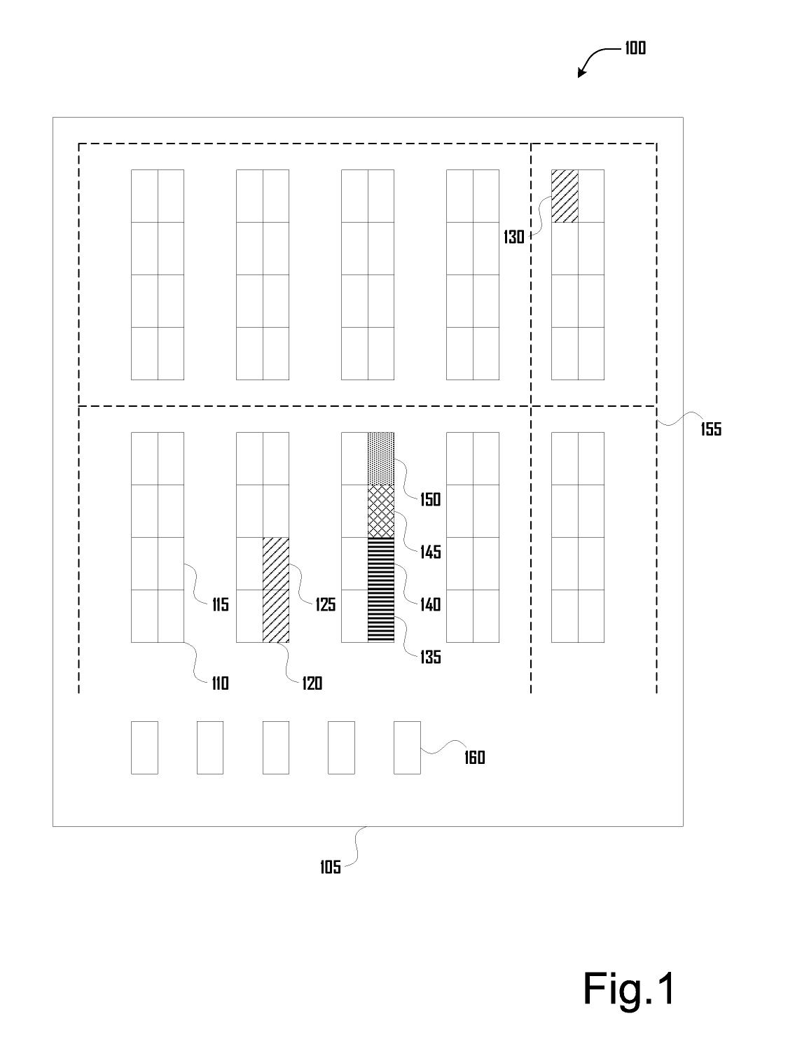

As used herein, “bay” or “rack” is a unit area in a store comprising a rack of shelves. Typically, within one store, racks or bays of consistent size(s) are obtained and placed, adjacent to one another, forming aisles. Bays may have sub-sections, comprising vertical or horizontal divisions comprising shelf(ves). Half-bays and other fractions of bays may be discussed. Examples of two “bays” are Bay 110 and Bay 115 in FIG. 1; other than block 105, the other numbered blocks in FIG. 1 are also bays. A partial illustration of Aisles 155 is illustrated with dotted lines in FIG. 1.

As used herein, “POG” is an abbreviation of “planogram”; as used herein, POG or planogram is a shelf-sub-section, shelf, bay, or group of bays in a store where a category and/or brand-name of products or a product are found. Products in the group may not be physically contiguous. For instance, products in the “chewing gum” category may be found in multiple locations throughout a store; the “chewing gum” POG is a merchandising definition of the locations of all products in the ‘chewing gum’ category. For example, in FIG. 1, three Bays 120, 125, and 130 are illustrated with diagonal lines and may be understood as the “chewing gum POG” (Bays 120 and 125 being adjacent and contiguous, Bay 130 not being contiguous with Bays 120 and 125).

As used herein, “POG segment” is a mapping between a POG and a bay or bays (or bay sub-sections, if a POG occupies only part of a bay). In the example illustrated in FIG. 1 and discussed above, the chewing gum POG has three POG segments, Bays 120, 125, and 130.

As used herein, “POG configuration” is a one or more isolated or contiguous POG segments with respect to a particular POG. For example, in the case of the chewing gum POG illustrated in FIG. 1 and discussed above, POG segments 120 and 125 (which may be toward the checkout area) are a first POG configuration of the chewing gum POG, while the third POG segment, Bay 130 (which may near the pharmacy area), is a second POG configuration of the chewing gum POG.

As used herein, “layout” is defined as the set of POG configurations, for a POG, for a store. For example, in the case of the chewing gum POG, the above described layout is [2,1] POG configurations, meaning that there are two POG configurations in the store, the first of which having two bays, the second of which having one bay.

As used herein, “POG grouping” is defined as a POG configuration together with adjacent POG segments.

As used herein, “contiguous rackblock” is a group of bays that have been determined to be adjacent and contiguous and may contain multiple POG configurations.

Referring now to FIG. 1, illustrated is a plan-view of a venue or store 105, which venue is owned or operated by a merchant. As discussed, blocks 110 and 115 represent adjacent bays. Blocks 120, 125 and 130 are diagonally cross-hatched to represent that they contain one POG. Per the example discussed above, this POG may be a “chewing gum” POG, indicating that it contains chewing gum.

In FIG. 1, block 145 may be a particular POG or POG segment. Block 150 is a POG segment with right adjacency relative to the POG of block 145. Blocks 135 and 140 may be a different POG segment with left adjacency relative to the POG of block 145.

In FIG. 1, a partial set of aisles are indicated by dotted lines and number 155 and a line of checkouts is indicated, which checkout is labeled with number 160.

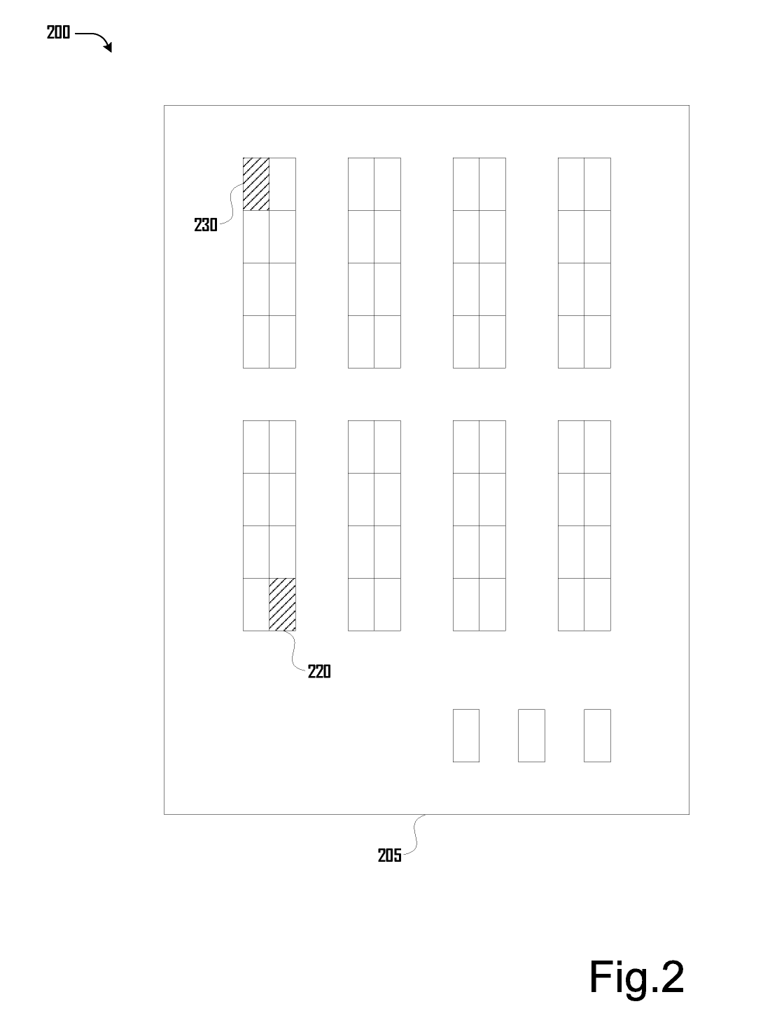

FIG. 2 is illustrates a different, smaller venue 205, for the first merchant. POG 220 and POG 230 may contain a chewing gum POG, as in FIG. 1, only the venue is smaller, with fewer aisles and rows.

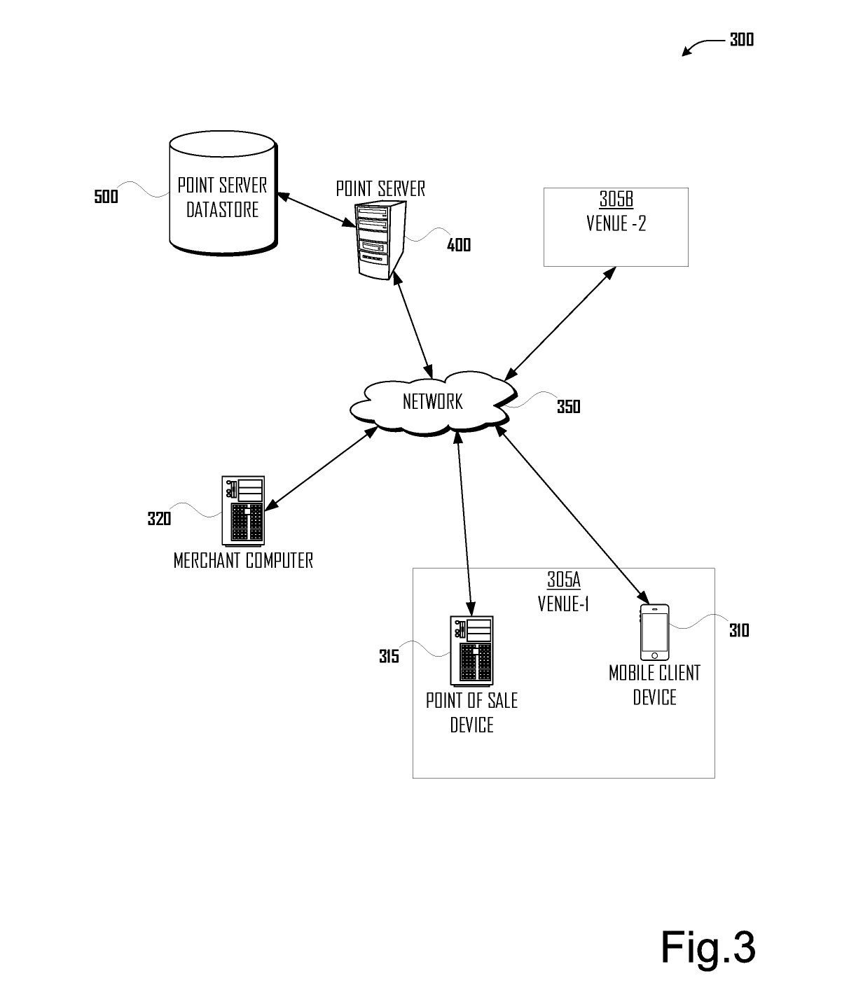

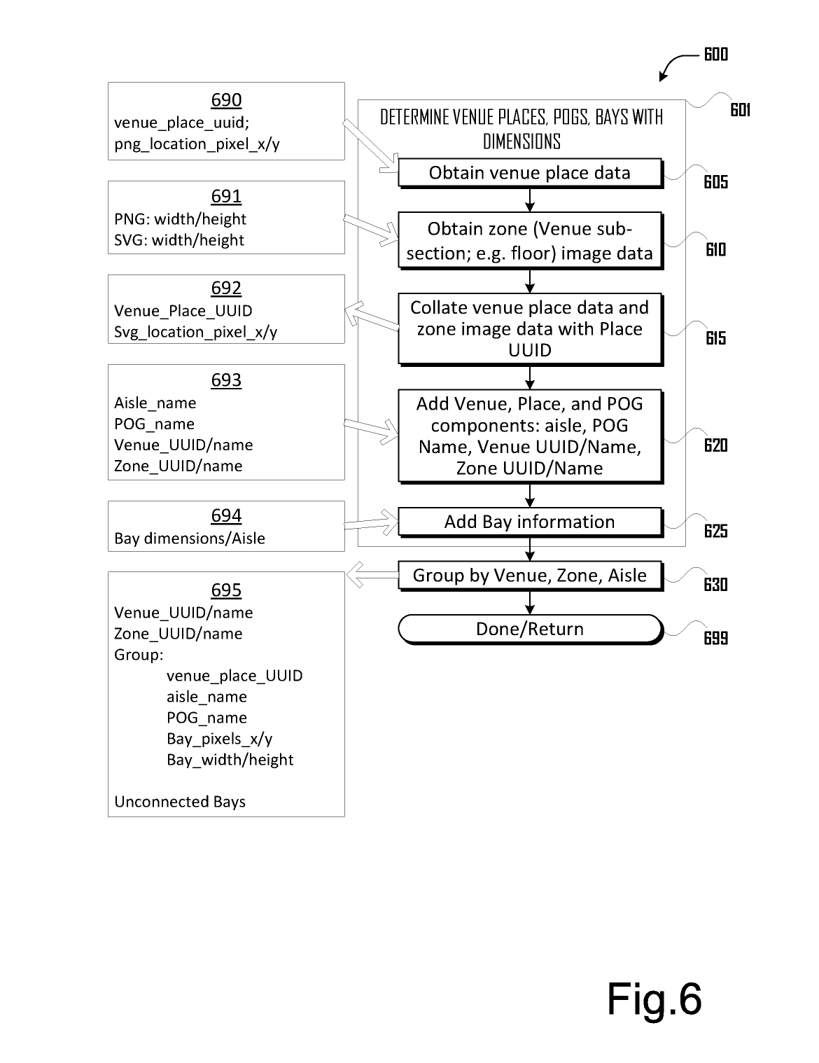

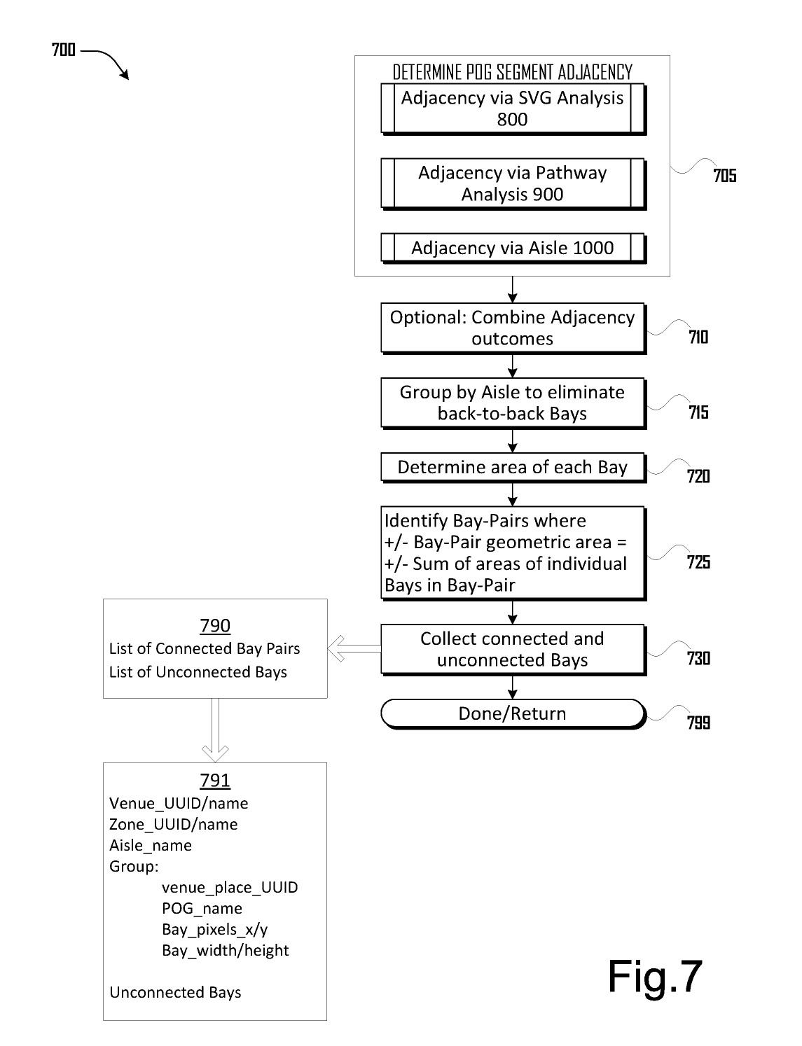

FIG. 3 illustrates a network and device diagram illustrating exemplary computer devices configured according to embodiments disclosed in this paper. Illustrated in FIG. 3 are Point Server 400 and Point Server Datastore 500. These computer devices may execute the routines or modules discussed herein (and described further below), such as Bay Map Module 600, Bay Connection Module 700, POG Configuration Layout Module 1100, Cross-Venue Comparison Module 1200, and GUI Module 1300. These modules are illustrated in corresponding figures (600 corresponding to FIG. 6, 700 corresponding to FIG. 7, etc.). In overview, a schema or map of bays for a venue may be created by Bay Map Module 600; the schema may include dimensions, aisles, and the names of the POGs found in the venue. Within the schema, adjacent POGs and connected bays may be determined by Bay Connection Module 700. Bay Connection Module 700 may determine adjacent POGs; three examples for determining adjacent POGs are illustrated as Adjacency via SVG Analysis 800, Adjacency via Pathway Analysis 900, and Adjacency via Aisle 1000. “POG configurations” (defined further herein) for a POG may be determined by POG Configuration Layout Module 1100. Each set of POG configurations for a POG in a venue is a “layout” of the POG. Layouts may be compared across venues by Cross-Venue Comparison Module 1200. GUI Module 1300 may get and displays information in a graphical user interface so that a POG and adjacent POGs can be compared across venues for a merchant.

Also illustrated in FIG. 3 is Merchant Computer 320. Merchant Computer 320 may be used by a retailer or merchant to interact with Point Server 400. Records regarding merchant may be stored in Point Server Datastore as one or Merchant 505 records.

Also illustrated in FIG. 3 are Venue-1 305A and Venue-2 305B, which may be individually referred to as Venue 305. Venue 305 represent stores or venues owned or operated by a merchant where products may be sold or offered for sale to customers. Information regarding venue may be stored in Point Server Datastore 500 as one or more Venue 510 records.

Plan-views of examples of Venues 305 are illustrated in FIGS. 1 and 2. As illustrated in Venue-1 305A, a Venue 305 may contain a Point of Sale Device 315, such as a cash register, and a Mobile Client Device 310. Mobile Client Device 310 may be used by a customer or visitor to the venue. The Mobile Client Device 310 may receive maps, including maps of Venue-1 305A, product information, may search and obtain information from, for example, the Internet.

Point Server 400, Merchant Computer 320, Point of Sale Device 315, and Mobile Client Device 320 may be, for example, a server computer, a mobile computer (such as a mobile “smart” phone, a tablet, or laptop computer), a personal computer, a gaming computer, and/or an Internet-enabled television, or similar computer device.

Network 350 may comprise computers, network connections among the computers, and software routines to enable communication between the computers over the network connections. Examples of Network 350 comprise an Ethernet network, the Internet, and/or a wireless network, such as a GSM, TDMA, CDMA, EDGE, HSPA, LTE or other network provided by a wireless service provider. Connection to Network 350 may be via a Wi-Fi connection. More than one network may be involved in a communication session between the illustrated devices. Connection to Network 350 may require that the computers execute software routines which enable, for example, the seven layers of the OSI model of computer networking or equivalent in a wireless phone network.

This paper may discuss a first computer as connecting to a second computer (such as Merchant Computer 320 connecting to Point Server 400) or to a corresponding datastore (such as to Point Server Datastore 500); it should be understood that such connections may be to, through, or via the other of the two components (for example, a statement that a computer device connects with or sends data to Point Server 400 should be understood as saying that the computer device may connect with or send data to the Point Server Datastore 500). References herein to “database” should be understood as equivalent to “Datastore.” Although illustrated as components integrated in one physical unit, the computers and databases may be provided by common (or separate) physical hardware and common (or separate) logic processors and memory components. Though discussed as occurring within one computer device, the software routines and data groups used by the software routines may be stored and/or executed remotely relative to any of the computers through, for example, application virtualization

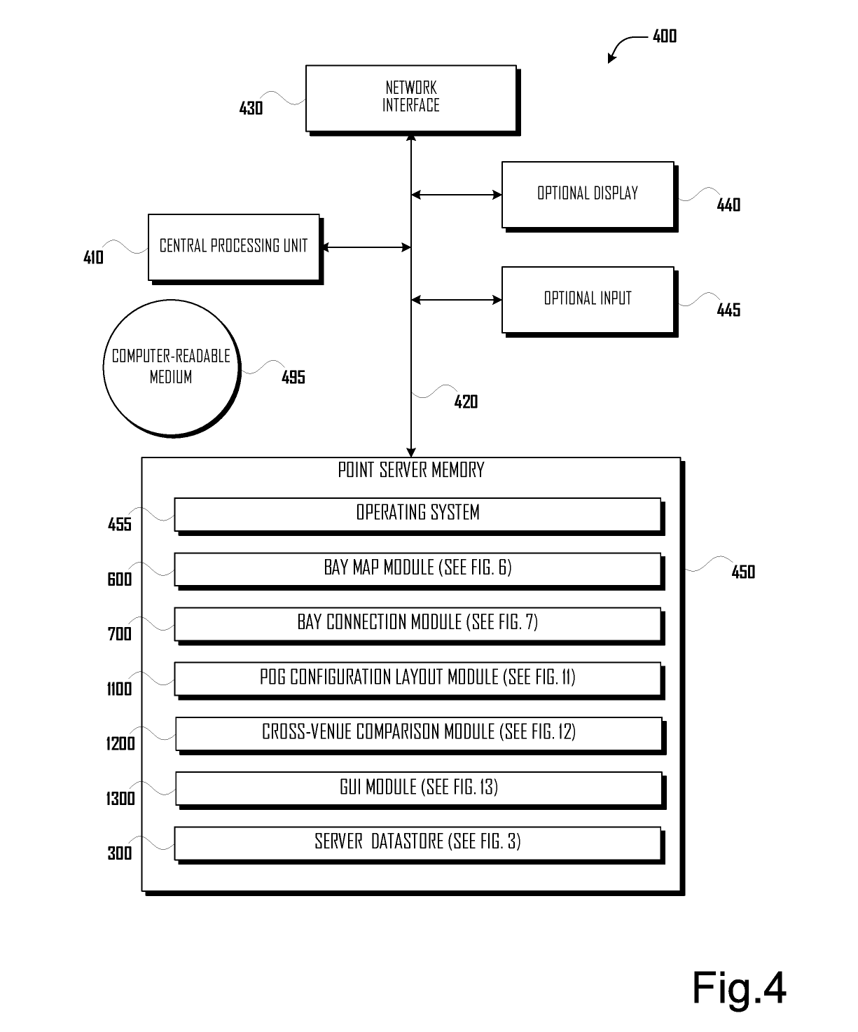

FIG. 4 is a functional block diagram of an exemplary Point Server 400 computer device and some data structures and/or components thereof. Point Server 400 comprises at least one Processing Unit 410, Point Server Memory 450, (optional) Display 440 and Input 445, all interconnected along with Network Interface 430 via Bus 420. Processing Unit 410 may comprise one or more general-purpose Central Processing Units (“CPU”) as well as one or more special-purpose Graphics Processing Units (“GPU”). The components of the Processing Unit 410 may be utilized by Operating System 455 for different functions required by the modules or routines executed by Point Server 400. Network Interface 430 may be utilized to form connections with Network 350 or to form device-to-device connections with other computers.

Point Server Memory 450 generally comprises a random access memory (“RAM”), a read only memory (“ROM”), and a permanent mass storage device, such as a disk drive or SDRAM (synchronous dynamic random-access memory). Point Server Memory 450 stores program code for software modules or routines, such as, for example, Bay Map Module 600, Bay Connection Module 700, Adjacency via SVG Analysis 800, Adjacency via Pathway Analysis 900, Adjacency via Aisle 1000, POG Configuration Layout Module 1100, Cross-Venue Comparison Module 1200, and GUI Module 1300, as well as, for example, browser, email client and server routines, client applications, and database applications (discussed further below). Additional data groups for modules or routines, such as for a webserver and web browser, may also be present on and executed by Point Server 400. Webserver and browser modules may provide an interface for interacting with the other computer devices illustrated in FIG. 3 or with other computer devices not illustrated in FIG. 3, for example, through webserver and web browser modules (which may serve and respond to data and information in the form of webpages and html documents or files). The browsers and webservers are meant to illustrate user-interface and user-interface enabling routines generally, and may be replaced by equivalent modules or routines for serving and rendering information to and in a device and/or user interface in a computer device (whether in a web browser or in, for example, a mobile device application).

In addition, Point Server Memory 450 also stores an Operating System 455. These software components may be loaded from a non-transient Computer Readable Storage Medium 495 into Point Server Memory 450 using a drive mechanism (not shown) associated with a non-transient Computer Readable Storage Medium 495, such as a floppy disc, tape, DVD/CD-ROM drive, memory card, or other like storage medium. In some embodiments, software components may also or instead be loaded via a mechanism other than a drive mechanism and Computer Readable Storage Medium 495 (e.g., via Network Interface 430).

Point Server 400 may also comprise hardware supporting input modalities, Input 445, such as, for example, a touchscreen, a camera, a keyboard, a mouse, a trackball, a stylus, motion detectors, and a microphone. Input 445 may also serve as Display 440, as in the case of a touchscreen display which also serves as Input 445, and which may respond to input in the form of contact by a finger or stylus with the surface of Input 445.

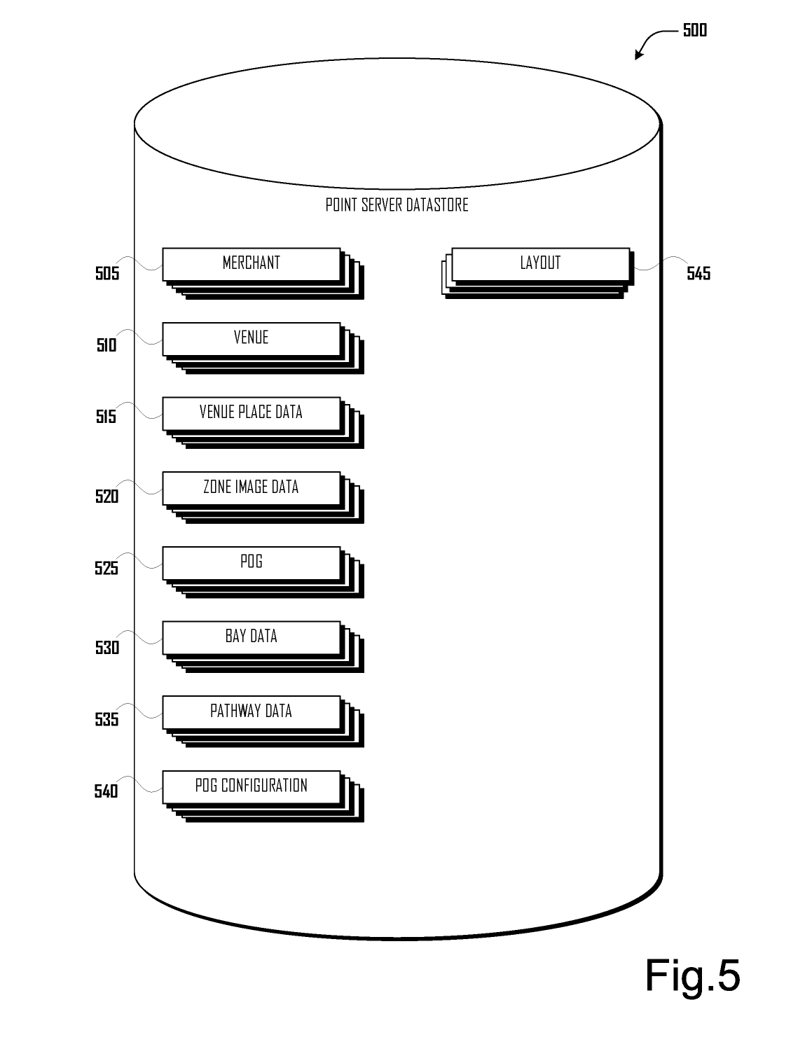

Point Server 400 may also comprise or communicate via Bus 420 with Point Server Datastore 500, illustrated further in FIG. 5. In various embodiments, Bus 420 may comprise a storage area network (“SAN”), a high speed serial bus, and/or via other suitable communication technology. In some embodiments, Point Server 400 may communicate with Point Server Datastore 500 via Network Interface 430. Point Server 400 may, in some embodiments, include many more components than those shown in this Figure. However, it is not necessary that all of these generally conventional components be shown in order to disclose an illustrative embodiment.

FIG. 5 is a functional block diagram of the Point Server Datastore 500 illustrated in the computer device of FIG. 4. The components of the Point Server Datastore 500 are data groups used by modules or routines. The data groups used by modules or routines illustrated in FIG. 5 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. The components of Point Server Datastore 500 are discussed further herein in the discussion of other of the Figures.

FIG. 6 is a flow diagram illustrating an example of a Bay Map Module 600, according to various embodiments. Bay Map Module 600 may prepare, for example, a schema or map of a venue and components therein.

In block 601, encompassing block 605 to block 625, Bay Map Module 600 prepares a schema or map of a venue from disparate data sources. Illustrating examples of this process, at block 605, Bay Map Module 600 may obtain venue place data or data regarding places or subcomponents of a venue. An example of venue place data is illustrated in block 690. Venue place data may be stored in Point Server Memory 500 as one or more Venue Place Data 515 record. Venue Place Data 515 may be obtained from, for example, by measurement of venue, from plans, photos, or pictures of a venue, from a merchant, including from Merchant Computer 320, or the like. The venue place data may comprise an identifier of each place within a venue and coordinates of pixels at such places.

At block 610, Bay Map Module 600 may obtain zone image data. A “zone” may be understood as a sub-section of a venue, such as a floor of a building, a department or the like. The zone image data may include width and height measurements (and potentially also a z-axis measurement) embodied in, for example, a scalable vector graphics (“SVG”) schema or similar data structure. Zone image data may be store in Point Server Datastore 500 as one or more Zone Image Data 520 records. An example of Zone Image Data 520 is illustrated at block 691.

Zone image data and venue place data may include a common reference or referenceable component which, at block 615, allows the venue place data and zone image data to be collated to produce place identifiers in association with height/width measurements and, for example, pixel coordinate data. An example of such a result is illustrated in block 692.

To the extent not already added and to the extent necessary, at block 620, Bay Map Module 600 may obtain additional venue, venue place, and POG components, such as aisle names, POG names, venue identifiers, and zone identifiers. This data may come from, for example, Venue Place Data 515, Zone Image Data 520, and POG 525 records. POG 525 records may comprise information regarding POGs, such as identifiers of different POGs in a venue, products, product identifiers (including trademarks, brand names, industry identifiers, product codes, and the like), or product categories in a POG, photographs of products, placement of products on shelves and the like. Information in POG 525 records may be obtained from, for example Merchant Computer 320, from third parties who place products in venues, from direct observation, and the like. An example of this data is illustrated in block 693.

To the extent not already added and to the extent necessary, at block 625, Bay Map Module 600 may add information regarding bay and aisle dimensions. This may describe types of different bays in a venue, shelves, aisles, dimensions, and the like. This information may be stored in, for example, one or more Bay Data 530 records. Information in Bay Data 530 records may be obtained from, for example Merchant Computer 320, from third parties, from direct observation, and the like. An example of this information is illustrated in block 694.

At block 630, Bay Map Module 600 may, for example, group the venue place data, zone image data, POG, bay, and aisle information. The grouping may be according to venue and, for example, zone and aisle. An example of a result of this block is illustrated in block 695. The result may include bays which are connected in aisles as well as bays which are unconnected.

At block 699, Bay Map Module 600 may conclude and/or may return to another module, routine, or process which spawned it.

FIG. 7 is a flow diagram illustrating an example of a Bay Connection Module 700, according to various embodiments. Bay Connection Module 700 may determine adjacent and/or contiguous POGs.

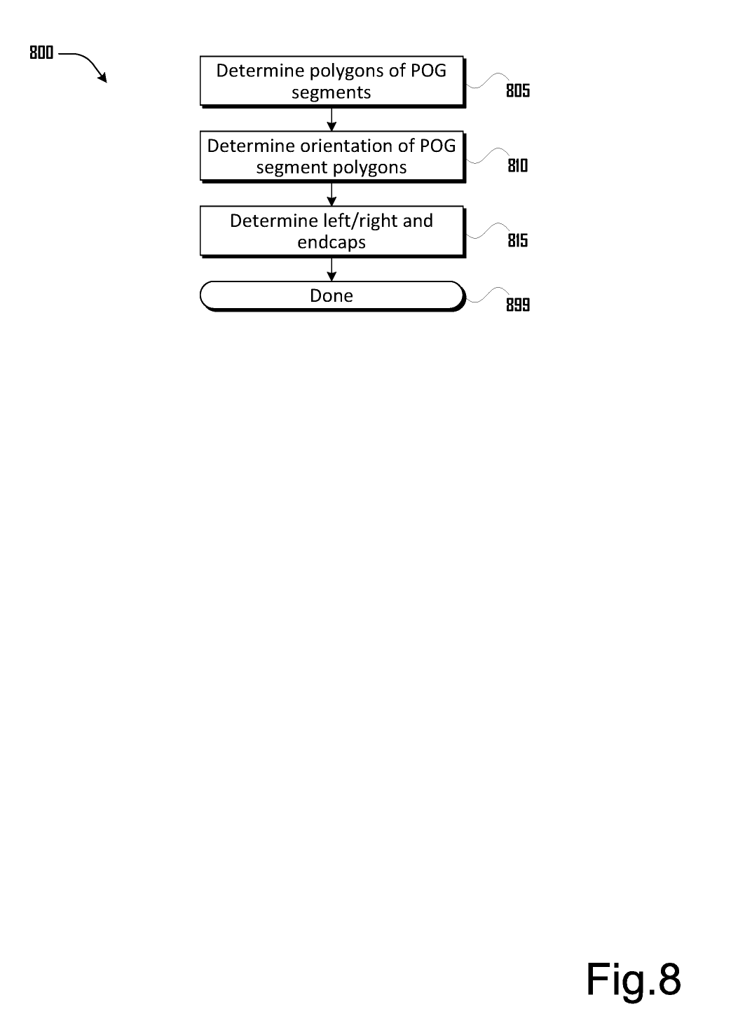

At block 705, Bay Connection Module 700 may determine or obtain adjacency for POG segments in a venue and/or venue zone. If not given, three examples of ways to determine such adjacency are illustrated in FIGS. 8-10.

Turning to FIG. 8, FIG. 8 is a flow diagram illustrating an example of an Adjacency via SVG Analysis Module 800, according to various embodiments. At block 805, Adjacency via SVG Analysis Module 800 may determine polygons of POG segments. As defined herein, a “POG segment” is a mapping between a POG and a bay or bays (or bay sub-sections, if a POG occupies only part of a bay). The POG segment may be identified by a point within a bay and a POG identifier, but determining adjacency may be aided by knowing the edges of the polygon (or other shape) around the point. This may be determined at block 805, utilizing SVG data from, for example, Venue Place Data 515, Zone Image Data 520, POG 525, and Bay Data 530 records and/or a result of Bay Map Module 600. At block 810, Adjacency via SVG Analysis Module 800 may determine the orientation of the POG segment polygons. The orientation may be relative to an absolute orientation (such as magnetic North) or an assigned orientation (assigned in a consistent way for a venue). At block 815, for each POG segment polygon, the neighboring left/right POG segments may be obtained as well as endcaps (POG segments on an end of an aisle). At block 899, Adjacency via SVG Analysis Module 800 may conclude and/or return to a process, routine, or module which may have spawned it. Benefits of Adjacency via SVG Analysis Module 800 may include that analysis of SVG is relatively straight-forward, however, the SVG data may not include orientation information and differentiating pathways (valid places for customers to walk), aisles, from POG segments may be difficult. This approach may require files or information outside of the raw dataset.

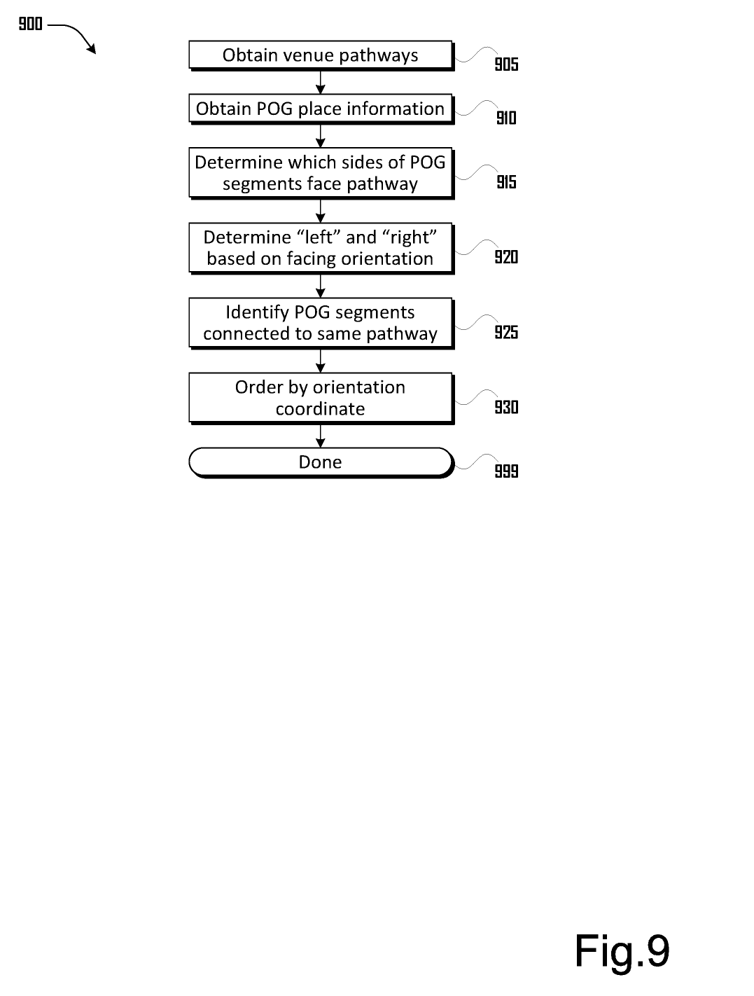

Turning to another example for determining POG adjacency, FIG. 9 is a flow diagram illustrating an example of an Adjacency via Pathway Analysis Module 900, according to various embodiments. At block 905, Adjacency via Pathway Analysis Module 900 may obtain venue pathway or aisle information. At block 910, Adjacency via Pathway Analysis Module 900 may obtain place information for POGs, including, for example, POG segment information. At block 915, Adjacency via Pathway Analysis Module 900 may determine which sides of POG segments face which pathways or aisles. At block 920, Adjacency via Pathway Analysis Module 900 may determine “left” and “right” adjacency for each POG segment based on orientation relative to which sides of POG segments face which pathways or aisles. At block 925, Adjacency via Pathway Analysis Module 900 may identify POG segments connected to the same pathway or aisle. An orientation coordinate (either X or Y) may be selected or assigned and, at block 930, Adjacency via Pathway Analysis Module 900 may order the connected POG segments by orientation coordinate. At block 999, Adjacency via Pathway Analysis Module 900 may conclude or return to a process which spawned it. Adjacency via Pathway Analysis Module 900 may handle orientation well, and may even handle diagonal pathways/aisles, though may have drawbacks, such as, for example, pathways which may not be contiguous along a contiguous POG segment.

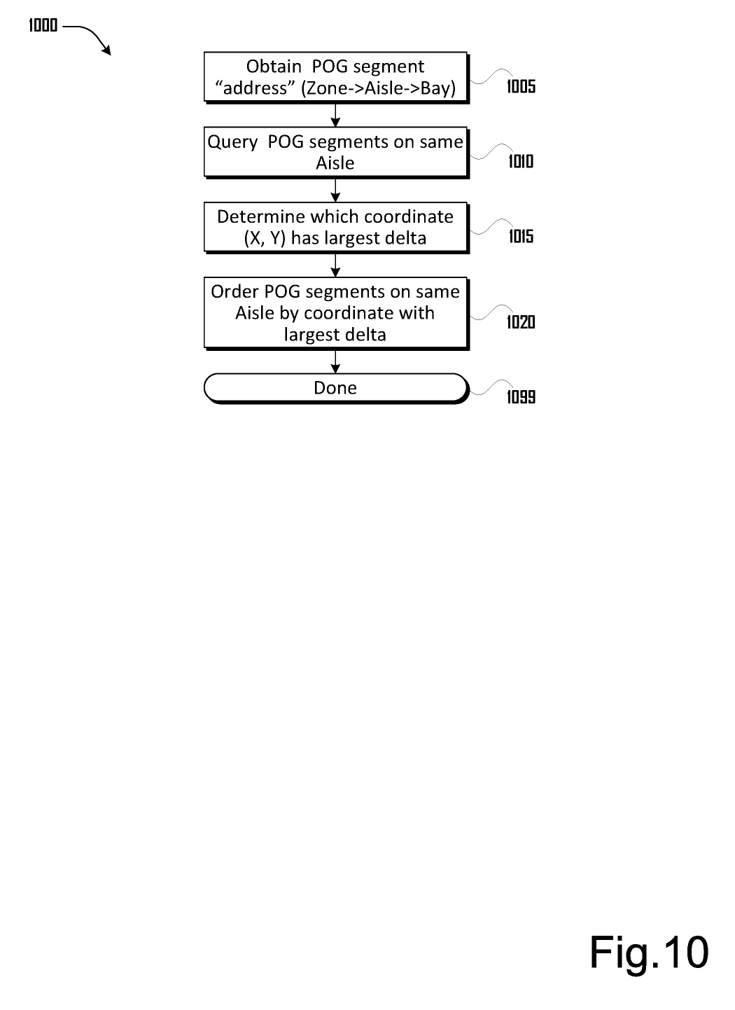

Turning to another example for determining POG adjacency, FIG. 10 is a flow diagram illustrating an example of an Adjacency via Aisle Module 1000, according to various embodiments. Adjacency via Aisle Module 1000 determines POG segment adjacency according to an “address” of each POG segment. At block 1005, Adjacency via Aisle Module 1000 obtains the POG segment “address”, such as a zone-aisle-bay for each POG segment. At block 1010, Adjacency via Aisle Module 1000 may query for POG segments on a same aisle and then, at block 1015, within the aisle, may determine which coordinate (X, Y) has a largest delta. At block 1020, Adjacency via Aisle Module 1000 may then order POG segments on a same aisle according to the coordinate with the largest delta. At block 1099, Adjacency via Aisle Module 1000 may conclude and/or return to a process which spawned it. This approach may provide benefits such as relatively quick implementation using known database techniques (such as SQL queries), though it may not handle diagonals well, not all aisles in a venue will necessarily be labeled, not all POG segments may be on an aisle, and endcaps may not be identified.

Returning to FIG. 7, upon conclusion of block 705 and determination of POG segment adjacency, at block 710, Bay Connection Module 700 may optionally combine and/or score and combine adjacency outcomes of block 705.

At block 715, Bay Connection Module 700 may group POG segments by aisle to eliminate POG segments in back-to-back bays.

At block 720, Bay Connection Module 700 may determine an area for each bay.

At block 725, Bay Connection Module 700 may, for each pair of bays in a venue or venue zone, identify those bay-pairs where the approximate geometrically determined area of the bay-pair (based on, for example, X value delta for the bay-pair multiplied by Y value delta for the bay-pair or determining the total area within a perimeter including the bay-pair) is equal to the approximate sum of areas of individual bays in the bay-pair. These values should only be (approximately) equal when the bay-pairs on an aisle are connected. When they are not connected, the geometrically determined area will be larger than the sum of the areas of the individual bays.

At block 730, Bay Connection Module 700 may output a list of connected bay pairs and a list of unconnected bays. An example of this output is illustrated in block 790 and 791.

At block 799, Bay Connection Module 700 may conclude and/or return to a process which spawned it.

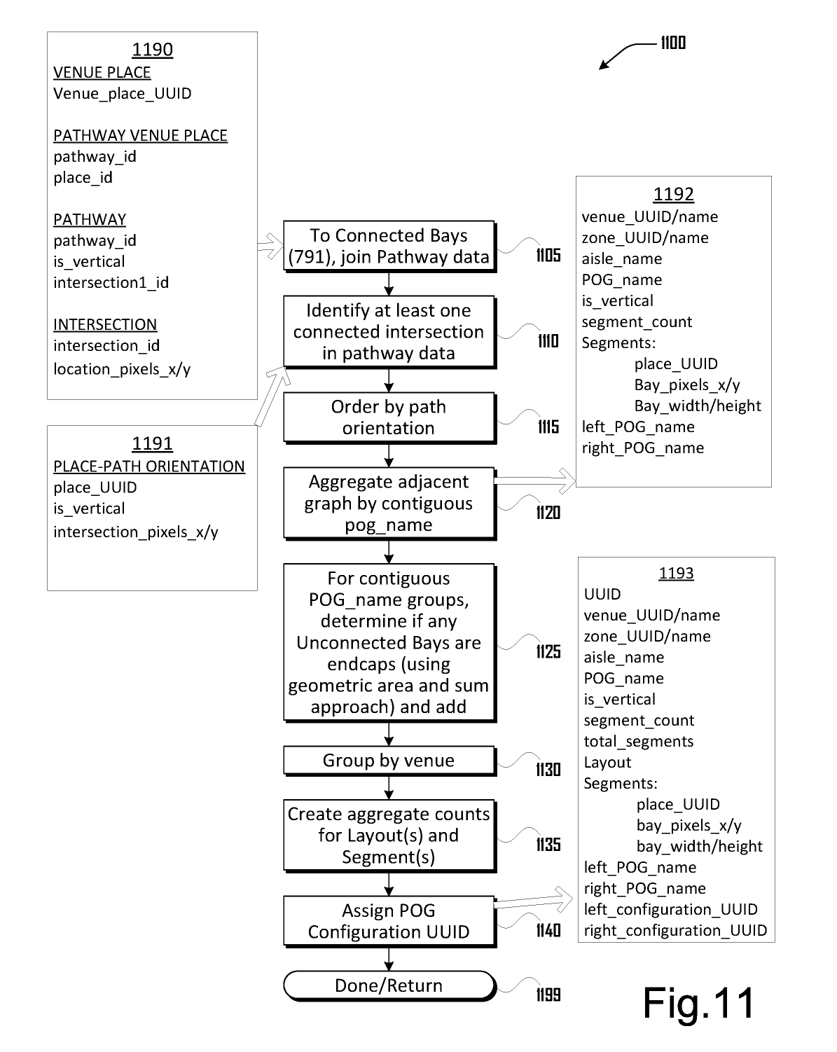

Turning to FIG. 11, FIG. 11 is a flow diagram illustrating an example of POG Configuration Layout Module 1100, according to various embodiments. This module may determine POG configurations and layouts. As noted elsewhere herein, as used herein, “POG configuration” is a one or more isolated or contiguous POG segments with respect to a particular POG while “layout” is defined as the set of POG configurations, for a POG, for a store. For example, in the case of the chewing gum POG illustrated in FIG. 1 and discussed above, POG segments 120 and 125 (which may be toward the checkout area) are a first POG configuration of the chewing gum POG, while the third POG segment, Bay 130 (which may near the pharmacy area), is a second POG configuration of the chewing gum POG. In the case of the chewing gum POG, the above described layout is [2,1] POG configurations, meaning that there are two POG configurations in the store, the first of which having two bays, the second of which having one bay.

At block 1105, POG Configuration Layout Module 1100 may join to connected bays (illustrated, for example, in block 790 and 791) pathway data. To the extent not already part of another record, an example of pathway data is illustrated in block 1190. To the extent not already part of another record, pathway data may be stored in Point Server Datastore 500 as Pathway Data 535.

At block 1110, POG Configuration Layout Module 1100 may identify at least one connected intersection in the pathway data. An example of such data is illustrated in block 1191.

At block 1115, POG Configuration Layout Module 1100 may order a result of the foregoing by path orientation. Logic for this ordering may be according to the following table:

TABLE 1

| is_vertical | Intersection coordinate | Facing | Ordering |
|---|---|---|---|
| True | X | Xᵢₙₜ < X_{bay} = W | Increasing Y |
| True | X | Xᵢₙₜ > X_{bay} = E | Decreasing Y |
| False | Y | Yᵢₙₜ < Y_{bay} = N | Increasing X |
| False | Y | Yᵢₙₜ > Y_{bay} = S | Decreasing X |

Thus, if the pathway is vertical, POG Configuration Layout Module 1100 looks at the X coordinate to determine facing. If the X coordinate of the intersection is less than that of the bay, then the bay is facing West (in terms of the store), and POG Configuration Layout Module 1100 orders the points in the graph according to increasing Y to determine “left” vs “right”. The same process is applied for each of the directions in order to determine left vs right ordering. The final output of the ordering process should have a data structure giving the graph in ordered progression from left to right.

At block 1120, POG Configuration Layout Module 1100 may aggregate the adjacency graph of block 1115 by contiguous POG name, finding ordered segments of connected bays in the same POG in the same aisle. During this process the names of left and right POGs (or POG segments) will be populated for each POG segment. An identifier for each POG configuration may also be generated for each POG configuration, allowing application of a reference to left and right POG configurations. An example of this result is illustrated in block 1192.

At block 1125, for contiguous POG name groups, a determination may be made regarding whether any unconnected bays (illustrated in block 791) are endcaps, such as according to the geometric area and sum approach discussed above in relation to block 725. If so, the endcaps may be added to the contiguous POG name groups.

At block 1130, POG Configuration Layout Module 1100 may group the result of block 1125 by venue and, at block 1135, may create aggregate counts for layouts and POG segments configuration. For example, in the case of the chewing gum POG, this block produces the numbers “2” and “1” which describe the number of POG segments in the POG configurations “2” and “1” in the layout, [2,1] POG configurations, for the chewing gum POG. Layouts may be assigned a layout identifier, which layout identifier may be stored in Point Server Datastore 500 as one or more Layout 545 records. At block 1140, POG Configuration Layout Module 1100 may assign a POG configuration identifier, which may be stored as one or more POG Configuration 540 records in Point Server Datastore 500. An example of a result of block 1140 is illustrated in block 1193. At block 1199, POG Configuration Layout Module 1100 may conclude and/or return to a process which spawned it.

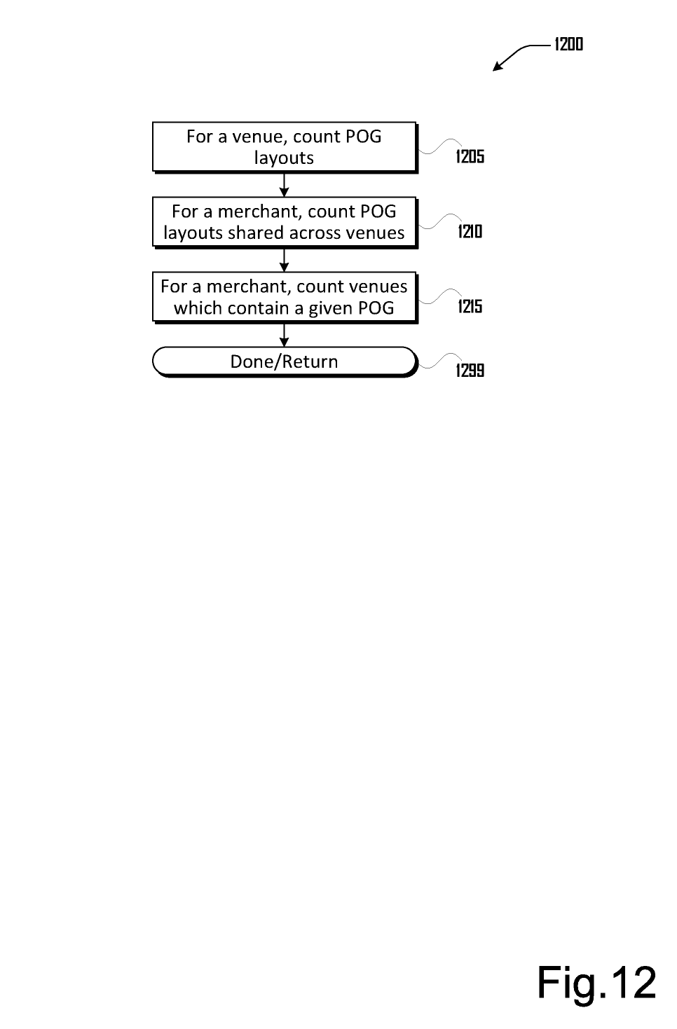

FIG. 12 is a flow diagram illustrating an example of Cross-Venue Comparison Module 1200, according to various embodiments. If not already performed, at block 1205, Cross-Venue Comparison Module 1200 may count the layouts for a venue. At block 1210, Cross-Venue Comparison Module 1200 may, for each merchant, count layouts shared across all venues of the merchant. For example, in the case of the chewing gum layout of [2,1] (discussed above), the result of this block will allow an answer to a question such as, “How many chewing gum layouts of [2,1] does the merchant have across all venues of the merchant?”

At block 1215, Cross-Venue Comparison Module 1200 may, for each merchant, count the venues which contain a given POG.

At block 1299, Cross-Venue Comparison Module 1200 may conclude or return to a process which spawned it.

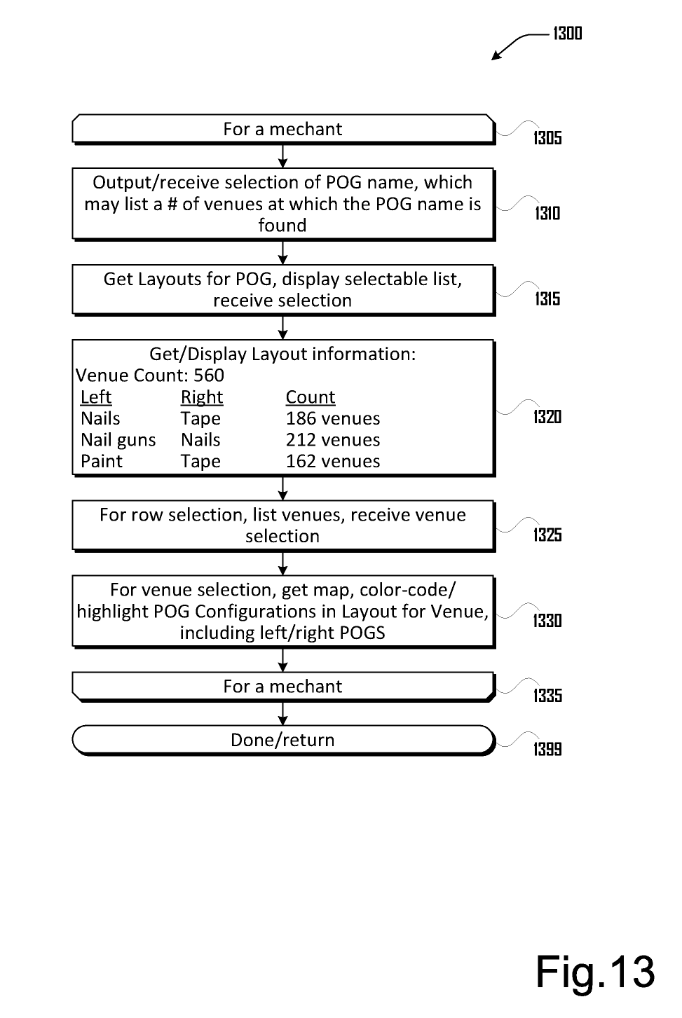

An example of use of the foregoing data is to use it in a graphical user interface (“GUI”) to allow merchants to understand and plan changes to POGs in venues. For example, FIG. 13 is a flow diagram illustrating an example of GUI Module 1300, according to various embodiments. GUI Module 1300 may manage and output to a GUI, such as a GUI in Merchant Computer 320, the information regarding POG adjacency created as discussed above.

Opening loop block 1305 to closing loop block 1335 may iterate for a merchant (such as according to a merchant selected by or associated with a user).

At block 1310, GUI Module 1300 may output and receive a selection of a POG name or other POG identifier, such as selection of the chewing gum POG. The POG name, as output in the GUI, may list the POG name as well as a number of venues at which the POG name is found. For example, the GUI may output a selectable list of POG names, such as the following:

Hammers (1801 venues)

Home Furnishings (1200 venues)

Housewares (1765 venues)

At block 1315, GUI Module 1300 may obtain the layouts for the selected POG name (of block 1310) across the venues of the merchant, the number of such venues, and may output the layouts and venues as a selectable list. For example, if a user selects “Hammers (1801 venues)” in the foregoing list of selectable POG names, the selectable list of layouts may look like, for example, the following:

[2 bay, 3 bay]—560 venues

[4 bay]—200 venues

[1 bay, 3 bay]—150 venues

[12 bay]—1 venue

At block 1320, may receive a selection of a layout and, for such selection, may obtain and output information regarding the left and right adjacent POGs names and the number of venues with the layout. An example of this output is illustrated in block 1320.

At block 1325, GUI Module 1300 may receive a selection of a row and may obtain and output a list of venues (for example, if the first row was selected at block 1320, a list of 186 venues may be obtained). The list of venues may be output in a map form, to allow the user to rapidly understand the geographic distribution of the selection. At block 1325, GUI Module 1300 may also receive a selection of a venue.

At block 1330, GUI Module 1300 may, for the selected venue, obtain a map or plan-view of the venue or a zone within the venue, as may be found, for example, in a Venue Place Data 515 or Zone Image Data 520 record. GUI Module 1300 may highlight and/or color code the POG configurations in the layout for the venue (or venue zone), including distinguishing color coding of left and right POGs. For example, as illustrated in FIG. 1, GUI Module 1300 may output a plan-view of a venue zone, highlighting block 145 as a selected POG configuration (which may have only one bay), with left POGs highlighted in blocks 135 and 140 and right POGs highlighted in block 150 (blocks 120, 125, and 130 may not be highlighted, in this example).

This allows a store planner to quickly understand what POG segments might be impacted by a change in a POG found in block 145, as well as to understand how many venues share the same (or a very similar) layout.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computer system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

### EXAMPLE 1

An apparatus for comparing planograms across retail venues, comprising: an intra-venue mapper module, an intra-venue adjacency module, an intra-venue layout module, a cross-venue comparison module, and a cross-venue planogram planning module; wherein the intra-venue mapper module is to map a venue, wherein to map the venue the intra-venue mapper module is to, with respect to a first venue, combine information for at least a set of bays, a set of planograms for a set of products, and a dimension of a first bay, wherein at least a first planogram segment of a first planogram is in the first bay; wherein the intra-venue adjacency module is to determine adjacency of planogram segments, wherein to determine adjacency of planogram segments, the intra-venue adjacency module is to determine a second planogram segment adjacent to the first planogram segment; wherein the intra-venue layout module is to determine planogram layouts, wherein to determine planogram layouts, the intra-venue layout module is to determine a first planogram layout for a first planogram in the set of planograms, the first planogram layout comprising a set of planogram configurations; wherein the cross-venue comparison module is to compare planogram layouts across venues, wherein to compare planogram layouts across venues, the cross-venue comparison module is to compare the first planogram layout to a second planogram layout for a second venue; and wherein the cross-venue planogram planning module is to facilitate planogram planning, wherein to facilitate planogram planning comprises to display a number of venues with the first and second planogram layouts.

### EXAMPLE 2

The apparatus according to Example 1, wherein the set of planograms for the set of products is a set of planograms for a set of product categories or a set of planograms for a set of product brand names.

### EXAMPLE 3

The apparatus according to Example 1, wherein the intra-venue mapper module is further to combine the set of bays in the first venue, a set of aisles in the first venue, the set of planograms, and a graphical representation of the first venue to produce the map of the first venue.

### EXAMPLE 4

The apparatus according to Example 1, wherein the intra-venue adjacency module is further to determine a set of connected bays within the set of bays.

### EXAMPLE 5

The apparatus according to Example 4, wherein the intra-venue adjacency module is to determine the set of planogram configurations by identifying isolated and contiguous planogram segments with a common planogram identifier relative to the set of bays and the set of connected bays.

### EXAMPLE 6

The apparatus according to Example 5, wherein the intra-venue layout module is to identify isolated and contiguous planogram segments by adding to the connected bays at least one intersection in the set of aisles, ordering the connected bays according to orientation relative to the at least one intersection in the set of aisles, identifying contiguous planogram segments according to a set of planogram identifiers and the connected bays, and identifying a planogram identifier for each planogram segment on either side of each contiguous planogram segment.

### EXAMPLE 7

The apparatus according to Example 4, wherein the intra-venue adjacency module is to determine the area of each bay in the set of bays, and is to, for each bay-pair in the set of bays, determine a bay-pair for which the combined area of each bay in the bay-pair approximately equals a geometric area of the bay-pair, and is to determine the bays in the bay-pair to be connected bays.

### EXAMPLE 8

The apparatus according to Example 1, wherein the intra-venue adjacency module is to determine the set of adjacent planogram segments according to at least one of an analysis of a graphical representation of the venue, an analysis of planogram segment orientation relative to pathway, and/or an analysis of an address of a set of planogram segment addresses.

### EXAMPLE 9

The apparatus according to Example 1, wherein the cross-venue comparison module is further to count a first number of venues with the first planogram layout and a second number of venues with the second planogram layout.

### EXAMPLE 10

The apparatus according to Example 1, wherein the cross-venue comparison module is to receive a selection of a planogram identifier, obtain a number of planogram layouts at a number of venues, receive a selection of the first venue, and display the map of the first venue comprising the first planogram layout and identifying a right or left planogram configuration on at least one side of a planogram configuration of the first layout.

### EXAMPLE 11

A computer implemented method of comparing planograms across retail venues, comprising: creating a map of a first venue, which map comprises a set of bays, a set of planograms for a set of products, and a dimension of a first bay, wherein at least a first planogram segment of a first planogram is in the first bay; determining a second planogram segment adjacent to the first planogram segment; determining a first planogram layout for a first planogram in the set of planograms, the first planogram layout comprising a set of planogram configurations; comparing the first planogram layout to a second planogram layout for a second venue; and displaying a number of venues with the first and second planogram layouts.

### EXAMPLE 12

The method according to Example 11, wherein the set of planograms for the set of products is a set of planograms for a set of product categories or a set of planograms for a set of product brand names.

### EXAMPLE 13

The method according to Example 11, further comprising combining the set of bays in the first venue, a set of aisles in the first venue, the set of planograms, and a graphical representation of the first venue to produce the map of the first venue.

### EXAMPLE 14

The method according to Example 11, further comprising determining a set of connected bays within the set of bays.

### EXAMPLE 15

The method according to Example 14, further comprising determining the set of planogram configurations by identifying isolated and contiguous planogram segments with a common planogram identifier relative to the set of bays and the set of connected bays.

### EXAMPLE 16

The method according to Example 15, further comprising identifying isolated and contiguous planogram segments by adding to the connected bays at least one intersection in the set of aisles, ordering the connected bays according to orientation relative to the at least one intersection in the set of aisles, identifying contiguous planogram segments according to a set of planogram identifiers and the connected bays, and identifying a planogram identifier for each planogram segment on either side of each contiguous planogram segment.

### EXAMPLE 17

The method according to Example 14, wherein the intra-venue adjacency module is to determine the area of each bay in the set of bays, and is to, for each bay-pair in the set of bays, determine a bay-pair for which the combined area of each bay in the bay-pair approximately equals a geometric area of the bay-pair, and is to determine the bays in the bay-pair to be connected bays.

### EXAMPLE 18

The method according to Example 11, further comprising determining the set of adjacent planogram segments according to at least one of an analysis of a graphical representation of the venue, an analysis of planogram segment orientation relative to pathway, and/or an analysis of an address of a set of planogram segment addresses.

### EXAMPLE 19

The method according to Example 11, wherein the cross-venue comparison module is to count a first number of venues with the first planogram layout and a second number of venues with the second planogram layout.

### EXAMPLE 20

The method according to Example 11, wherein the cross-venue comparison module is to receive a selection of a planogram identifier, obtain a number of planogram layouts at a number of venues, receive a selection of the first venue, and display the map of the first venue comprising the first planogram layout and identifying a planogram configuration on at least one side of a planogram configuration in the first layout.

### EXAMPLE 21

An apparatus for comparing planograms across retail venues, comprising: means to produce a map of a first venue comprising a set of bays, a set of planograms for a set of products, and a dimension of a first bay, wherein at least a first planogram segment of a first planogram is in the first bay; means to determine a second planogram segment adjacent to the first planogram segment; means to determine a first planogram layout for a first planogram in the set of planograms, the first planogram layout comprising a set of planogram configurations; means to compare the first planogram layout to a second planogram layout for a second venue; and means to display a number of venues with the first and second planogram layouts.

### EXAMPLE 22

One or more computer-readable media comprising instructions that cause a computing device, in response to execution of the instructions by one or more processors of the computing device, to compare planograms across retail venues by: creating a map of a first venue, which map comprises a set of bays, a set of planograms for a set of products, and a dimension of a first bay, wherein at least a first planogram segment of a first planogram is in the first bay; determining a second planogram segment adjacent to the first planogram segment; determining a first planogram layout for a first planogram in the set of planograms, the first planogram layout comprising a set of planogram configurations; comparing the first planogram layout to a second planogram layout for a second venue; and displaying a number of venues with the first and second planogram layouts.

The above Detailed Description is not intended to be exhaustive or to limit the disclosure to the precise form disclosed above. While specific embodiments of, and examples for, the disclosure are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

What is claimed is:

1. An apparatus for comparing planograms across retail venues, comprising:
an intra-venue mapper module, an intra-venue adjacency module, an intra-venue layout module, a cross-venue comparison module, and a cross-venue planogram planning module;
wherein the intra-venue mapper module is to map a venue, wherein to map the venue the intra-venue mapper module is to, with respect to a first venue, combine information for at least a set of bays, a set of planograms for a set of products, and a dimension of a first bay, wherein at least a first planogram segment of a first planogram is in the first bay;
wherein the intra-venue adjacency module is to determine adjacency of planogram segments, wherein to determine adjacency of planogram segments, the intra-venue adjacency module is to determine a second planogram segment adjacent to the first planogram segment;
wherein the intra-venue layout module is to determine planogram layouts, wherein to determine planogram layouts, the intra-venue layout module is to determine a first planogram layout for a first planogram in the set of planograms, the first planogram layout comprising a set of planogram configurations;
wherein the cross-venue comparison module is to compare planogram layouts across venues, wherein to compare planogram layouts across venues, the cross-venue comparison module is to compare the first planogram layout to a second planogram layout for a second venue; and
wherein the cross-venue planogram planning module is to facilitate planogram planning, wherein to facilitate planogram planning comprises to display a number of venues with the first and second planogram layouts.

2. The apparatus according to claim 1, wherein the set of planograms for the set of products is a set of planograms for a set of product categories or a set of planograms for a set of product brand names.

3. The apparatus according to claim 1, wherein the intra-venue mapper module is further to combine the set of bays in the first venue, a set of aisles in the first venue, the set of planograms, and a graphical representation of the first venue to produce the map of the first venue.

4. The apparatus according to claim 1, wherein the intra-venue adjacency module is further to determine a set of connected bays within the set of bays.

5. The apparatus according to claim 4, wherein the intra-venue adjacency module is to determine the set of planogram configurations by identifying isolated and contiguous planogram segments with a common planogram identifier relative to the set of bays and the set of connected bays.

6. The apparatus according to claim 5, wherein the intra-venue layout module is to identify isolated and contiguous planogram segments by adding to the connected bays at least one intersection in the set of aisles, ordering the connected bays according to orientation relative to the at least one intersection in the set of aisles, identifying contiguous planogram segments according to a set of planogram identifiers and the connected bays, and identifying a planogram identifier for each planogram segment on either side of each contiguous planogram segment.

7. The apparatus according to claim 4, wherein the intra-venue adjacency module is to determine the area of each bay in the set of bays, and is to, for each bay-pair in the set of bays, determine a bay-pair for which the combined area of each bay in the bay-pair approximately equals a geometric area of the bay-pair, and is to determine the bays in the bay-pair to be connected bays.

8. The apparatus according to claim 1, wherein the intra-venue adjacency module is to determine the set of adjacent planogram segments according to at least one of an analysis of a graphical representation of the venue, an analysis of planogram segment orientation relative to pathway, and/or an analysis of an address of a set of planogram segment addresses.

9. The apparatus according to claim 1, wherein the cross-venue comparison module is further to count a first number of venues with the first planogram layout and a second number of venues with the second planogram layout.

10. The apparatus according to claim 1, wherein the cross-venue comparison module is to receive a selection of a planogram identifier, obtain a number of planogram layouts at a number of venues, receive a selection of the first venue, and display the map of the first venue comprising the first planogram layout and identifying a right or left planogram configuration on at least one side of a planogram configuration of the first layout.

11. A computer implemented method of comparing planograms across retail venues, comprising:
creating a map of a first venue, which map comprises a set of bays, a set of planograms for a set of products, and a dimension of a first bay, wherein at least a first planogram segment of a first planogram is in the first bay;
determining a second planogram segment adjacent to the first planogram segment;
determining a first planogram layout for a first planogram in the set of planograms, the first planogram layout comprising a set of planogram configurations;
comparing the first planogram layout to a second planogram layout for a second venue; and
displaying a number of venues with the first and second planogram layouts.

12. The method according to claim 11, wherein the set of planograms for the set of products is a set of planograms for a set of product categories or a set of planograms for a set of product brand names.

13. The method according to claim 11, further comprising combining the set of bays in the first venue, a set of aisles in the first venue, the set of planograms, and a graphical representation of the first venue to produce the map of the first venue.

14. The method according to claim 11, further comprising determining a set of connected bays within the set of bays.

15. The method according to claim 14, further comprising determining the set of planogram configurations by identifying isolated and contiguous planogram segments with a common planogram identifier relative to the set of bays and the set of connected bays.

16. The method according to claim 15, further comprising identifying isolated and contiguous planogram segments by adding to the connected bays at least one intersection in the set of aisles, ordering the connected bays according to orientation relative to the at least one intersection in the set of aisles, identifying contiguous planogram segments according to a set of planogram identifiers and the connected bays, and identifying a planogram identifier for each planogram segment on either side of each contiguous planogram segment.

17. The method according to claim 14, wherein the intra-venue adjacency module is to determine the area of each bay in the set of bays, and is to, for each bay-pair in the set of bays, determine a bay-pair for which the combined area of each bay in the bay-pair approximately equals a geometric area of the bay-pair, and is to determine the bays in the bay-pair to be connected bays.

18. The method according to claim 11, further comprising determining the set of adjacent planogram segments according to at least one of an analysis of a graphical representation of the venue, an analysis of planogram segment orientation relative to pathway, and/or an analysis of an address of a set of planogram segment addresses.

19. The method according to claim 11, wherein the cross-venue comparison module is to count a first number of venues with the first planogram layout and a second number of venues with the second planogram layout.

20. The method according to claim 11, wherein the cross-venue comparison module is to receive a selection of a planogram identifier, obtain a number of planogram layouts at a number of venues, receive a selection of the first venue, and display the map of the first venue comprising the first planogram layout and identifying a planogram configuration on at least one side of a planogram configuration in the first layout.

21. An apparatus for comparing planograms across retail venues, comprising:
means to produce a map of a first venue comprising a set of bays, a set of planograms for a set of products, and a dimension of a first bay, wherein at least a first planogram segment of a first planogram is in the first bay;
means to determine a second planogram segment adjacent to the first planogram segment;
means to determine a first planogram layout for a first planogram in the set of planograms, the first planogram layout comprising a set of planogram configurations;
means to compare the first planogram layout to a second planogram layout for a second venue; and
means to display a number of venues with the first and second planogram layouts.

22. One or more computer-readable media comprising instructions that cause a computing device, in response to execution of the instructions by one or more processors of the computing device, to compare planograms across retail venues by:
creating a map of a first venue, which map comprises a set of bays, a set of planograms for a set of products, and a dimension of a first bay, wherein at least a first planogram segment of a first planogram is in the first bay;
determining a second planogram segment adjacent to the first planogram segment;
determining a first planogram layout for a first planogram in the set of planograms, the first planogram layout comprising a set of planogram configurations;
comparing the first planogram layout to a second planogram layout for a second venue; and
displaying a number of venues with the first and second planogram layouts.
